(19) United States
(12) Patent Application Publication
(10) Pub. No.: US 2023/0221187 A1
(43) Pub. Date: Jul. 13, 2023

(54) DEVICE WITH A HIGH-TEMPERATURE INDICATOR FOR A WHEEL-END SYSTEM

(71) Applicant: Amsted Rail Company, Inc., Chicago, IL (US)

(72) Inventor: Brian Ford, Moseley, VA (US)

(21) Appl. No.: 17/573,352

(22) Filed: Jan. 11, 2022

(51) Int. Cl. G01K 5/70; B60B 27/00

(52) U.S. Cl. CPC G01K 5/70; B60B 27/0068; B60B 7/0013

(57) ABSTRACT

A device for a wheel-end system includes a component that defines a rotation axis and forms (i) a pocket extending axially downward from a top face of the component and (ii) a shaft extending axially downward from the top face and laterally adjacent to the pocket. The shaft is partially open to the pocket. A spring-loaded indicator is located in the shaft. The threaded fastener also includes a bimetallic strip located partially in the pocket and extending laterally into the shaft. The bimetallic strip has a movable end that axially restrains the spring-loaded indicator while a temperature of the nut is below a threshold temperature. The bimetallic strip, in response to the temperature exceeding the threshold temperature, laterally deflects the movable end to release the spring-loaded indicator. The component may be an axle nut, wheel hub, spacer, or hub cap.

### BACKGROUND

A wheel-end system (also known as a “wheel-end assembly” or simply “wheel end”) refers to components and parts used to position and secure a wheel to the drive axle of a vehicle. A typical wheel-end system includes a bearing, one or more seals, a hub, a brake rotor, a bearing spacer (e.g., a bushing), a threaded spindle, an axle nut, and a hub cap or center cap.

### SUMMARY

During operation, bearings may overheat and cause a catastrophic failure including the loss of a vehicle wheel if not caught in time. Inspecting for this issue can be difficult since it requires removal of the axle nut, whereupon a mechanic must visually look for signs of excessive heat. Furthermore, the bearing assembly typically is no longer hot when inspections take place, leaving the decision to inspect a bearing reliant on a judgement call or incomplete information.

The present embodiments include various devices for wheel-end systems, each of which incorporates a high-temperature indicator that is located on an outward-facing surface of the device. The term “outward-facing surface” is used herein to refer to any surface, either planar or non-planar (e.g., curved), that faces away from the bearing and bearing seals. Thus, when the device is installed as part of a wheel-end system, the high-temperature indicator is readily visible to a person (e.g., truck driver, mechanic, etc.) and not visibly occluded by the device itself.

The high-temperature indicators used in the present embodiments change from a below-threshold state to an above-threshold state in response to the temperature exceeding a threshold. These high-temperature indicators are bistable, meaning that they remain in the above-threshold state even after the temperature has returned to below the threshold. This bistable operation ensures that the person is notified of an excessive temperature that occurred in the past, such as when the person was driving the vehicle and therefore not looking at the indicator.

Upon seeing the above-threshold state, the person may then continue to inspect the wheel-end component to see if excessive temperature has caused damage or unacceptable levels of wear. As described in more detail below, some of the high-temperature indicators may be easily reset (e.g., manually), advantageously allowing them to be reused. The indicator is highly visible and does not require electrical power.

The devices of the present embodiments include any wheel-end component having an outward-facing surface. Examples of such wheel-end components include, but are not limited to, axle nuts, hub caps, center caps, wheel hubs, rims, and spacers. All of these components define a rotation axis and, when installed, are coaxial with the drive axle. While the present embodiments are described herein with respect to wheel-end systems and components for automotive vehicles, the high-temperature indicators can be alternatively incorporated into the outward-facing surface of other parts and systems. Examples of such parts include, but are not limited to, roller bearing wheels, fasteners (e.g., nuts, bolts, anchors, pins etc.), washers, clamps, and conveyors (e.g., turntables and conveyor belts).

In embodiments, a device for a wheel-end system includes a component of the wheel-end system that defines a rotation axis and forms a pocket extending axially downward from a top face of the component. The component also forms a shaft extending axially downward from the top face and laterally adjacent to the pocket. The shaft is partially open to the pocket. The device also includes a spring-loaded indicator located at least partially in the shaft and a bimetallic strip located partially in the pocket and extending laterally into the shaft. The bimetallic strip has a movable end that axially restrains the spring-loaded indicator while a temperature of the component is below a threshold temperature. The bimetallic strip, in response to the temperature exceeding the threshold temperature, laterally deflects the movable end to release the spring-loaded indicator.

In other embodiments, a device for a wheel-end system includes a component of the wheel-end system that defines a rotation axis and forms a pocket extending axially downward from a top face of the component. The device also includes an indicator located in the pocket and temperature-sensitive material that is located in the pocket and axially covering the indicator. The temperature-sensitive material, in response to reaching a threshold temperature, changes to a liquid that flows out of the pocket to visibly reveal the indicator.

In other embodiments, a device for a wheel-end system includes a component of the wheel-end system that defines a rotation axis and forms a shaft extending axially downward from a top face of the component. The device also includes a spring-loaded indicator located in the shaft and temperature-sensitive material located in the shaft to axially restrain the spring-loaded indicator. The temperature-sensitive material, in response to reaching a threshold temperature, softens or changes to a liquid to release the spring-loaded indicator.

### BRIEF DESCRIPTION OF THE FIGURES

FIG. 1 is an exploded view of a threaded fastener that affixes to a threaded spindle, in an embodiment.

FIG. 2A is a top view of a threaded fastener that uses a bimetallic spring to indicate high temperature, in an embodiment.

FIG. 2B shows the threaded fastener of FIG. 2A with a cover plate removed.

FIG. 2C is perspective view of the threaded fastener of FIG. 2A.

FIG. 3A is a top view of a flat coil spring that may be used with the threaded fastener of FIGS. 2A-2C, in an embodiment.

FIG. 3B is a perspective view of a helical coil spring that may be used with the threaded fastener of FIGS. 2A-2C, in an embodiment.

FIG. 4 is a side cutaway view of the threaded fastener of FIG. 2A, in an embodiment.

FIG. 5 is a side view of a pin used with the threaded fastener of FIGS. 2A-2C, in an embodiment.

FIG. 6A is a side cross-sectional view of a threaded fastener that uses a leaf spring to indicate high temperature, in an embodiment.

FIG. 6B is a cross-sectional view of the threaded fastener of FIG. 6A, in an embodiment.

FIG. 7A is a cross-sectional view of the threaded fastener of FIG. 6B when a threshold temperature has been reached or exceeded, in an embodiment.

FIG. 7B is a cross-sectional view of the threaded fastener of FIG. 6B.

FIG. 8A is a top view of a threaded fastener with a high-temperature indicator, in an embodiment.

FIG. 8B is a cross-sectional view of the threaded fastener of FIG. 8A, in an embodiment.

FIG. 8C is a perspective view of the threaded fastener of FIG. 8A.

FIG. 9A is a top view of a threaded fastener with a high-temperature indicator, in an embodiment.

FIG. 9B is perspective view of the threaded fastener of FIG. 9A.

FIG. 10 is a cross-sectional view of the threaded fastener of FIG. 9A, in an embodiment.

FIG. 11 is a top view of a threaded fastener with a high-temperature indicator, in an embodiment.

FIG. 12A is a side view of a u-shaped bimetallic strip used with the threaded fastener of FIG. 11.

FIG. 12B is a top view of the u-shaped bimetallic strip of FIG. 12A. s

### DETAILED DESCRIPTION

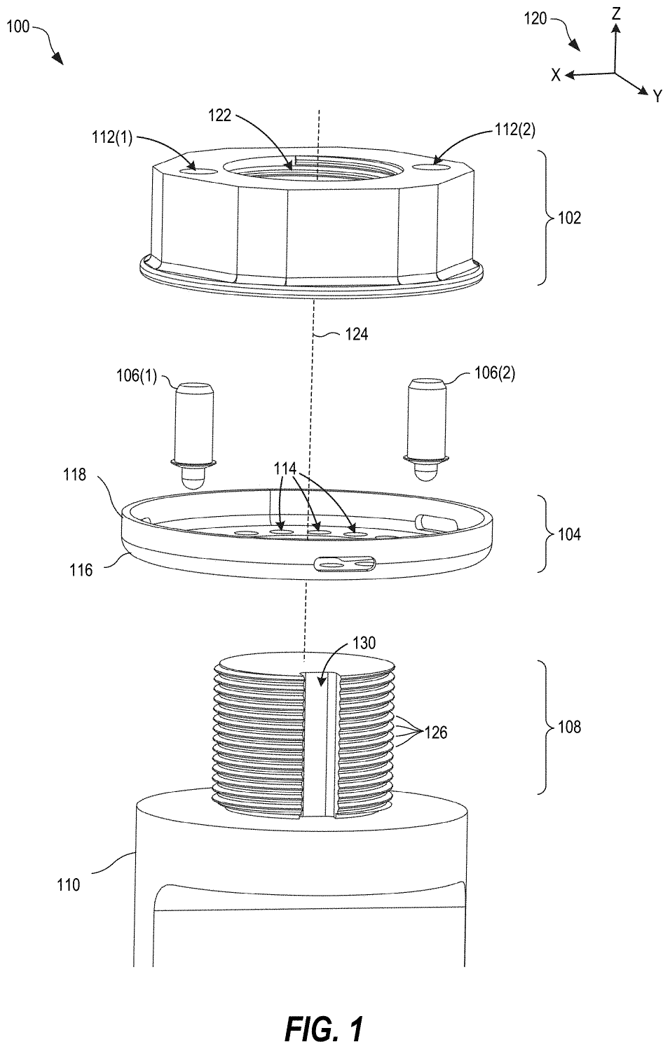

FIG. 1 is an exploded view of a threaded fastener 100 that affixes to a threaded spindle 108. The threaded spindle 108 may be attached or connected to a wheel bearing 110, as shown in FIG. 1. The threaded fastener 100 includes a nut 102 forming a threaded center hole 122 that is threaded to match external threads 126 of the spindle 108. The threaded center hole 122 and spindle 108 are coaxial to a rotation axis 124 about which nut 102 rotates, and along which nut 102 linearly translates, or advances, to engage with the external threads 126 of the spindle 108. For clarity herein, it is assumed that rotation axis 124 coincides with the z axis of a right-handed Cartesian coordinate system 120, wherein the nut 102 translates in the −z direction when engaging with the spindle 108, and in the +z direction when disengaging from the spindle 108.

The positioner 104 is shaped as a disc 116 that lies flat in the x-y plane and forms an unthreaded center hole through which the spindle 108 passes. The disc 116 also forms a sequence of recesses 114 located circumferentially around the unthreaded center hole. Extending axially upward (i.e., along the +z direction) from an outer edge of the disc 116 is a lip 118.

A slot 130 on the spindle 108 may engage with an inward facing radial tab (not shown) on the disc 116 to cooperatively prevent the positioner 104 from rotating about the rotation axis 124 while the nut 102 is engaged with the spindle 108. Affixed to the nut 102 circumferentially around the threaded center hole 122 are a plurality of spring plungers 106 that engage with the recesses 114. The plungers 106 cooperate with the recesses 114 to create a detent mechanism that both arrests motion of the nut 102 while it is being tightened onto the spindle 108 and divides rotation of the nut 102 into discrete angular increments about the rotation axis 124. In FIG. 1, the nut 102 forms a first plunger mounting hole 112(1) and a second plunger mounting hole 112(2) that receive a first spring plunger 106(1) and a second spring plunger 106(2), respectively. However, the threaded fastener 100 may alternatively have only one spring plunger 106 or more than two spring plungers 106 (and corresponding plunger mounting holes 112) without departing from the scope hereof.

As shown in FIG. 1, the nut 102 may be transversely (i.e., in the x-y plane) shaped as a truncated hexagon (i.e., a hexagon with each of its corners truncated to form an irregular twelve-sided polygon). Alternatively, the nut 102 may be transversely shaped as an untruncated regular hexagon, or another kind of regular or irregular polygon. Each of the spring plungers 106 may be positioned near a corner of the polygon, where there is generally more material to form a plunger mounting hole 112, as compared to regions away from the corners.

For purposes of illustration, FIG. 1 is a representative view of a fastener that may incorporate any of the embodiments disclosed herein. However, the fastener embodiments disclosed herein are not limited to the nut shown in FIG. 1 and may be applied to any fastener or device that operates in an environment where high temperature conditions may occur. Fasteners disclosed herein may or may not include the positioner 104 and spring plungers 106, for example.

A bearing may be used to provide smooth rotation of a wheel. Rotation of a wheel may generate high temperatures, and a bearing may be considered defective if it exceeds a threshold temperature that is typically higher than the ambient temperature. The threshold temperature may be, for example, 250° F. The present embodiments provide a visible indication that a bearing has exceeded the threshold temperature, possibly causing damage to the bearing. A high temperature indicator may be placed in an axle nut since the axle nut is visible when not occluded by a hub cap or center cap. The axle nut is located near the bearing and is therefore in good thermal contact with the bearing.

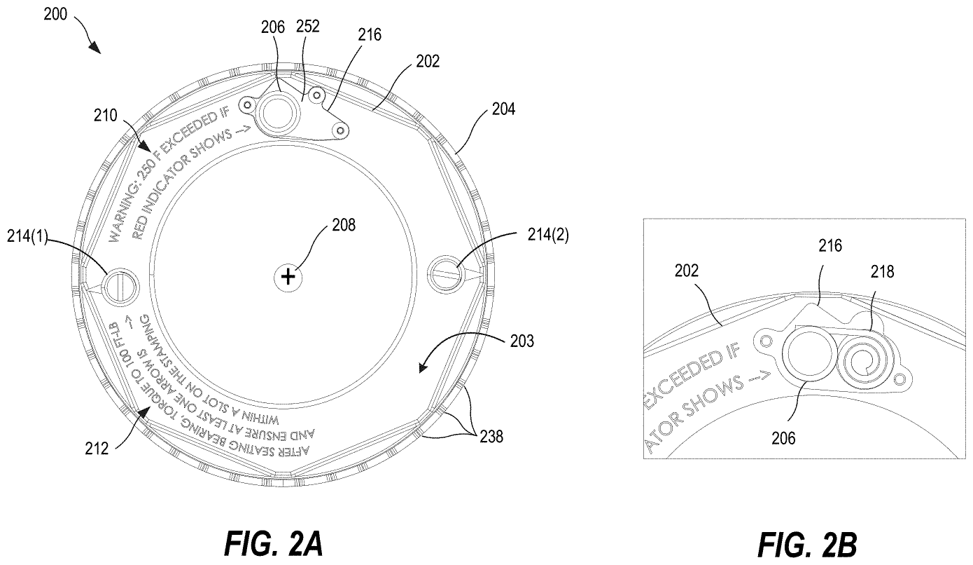

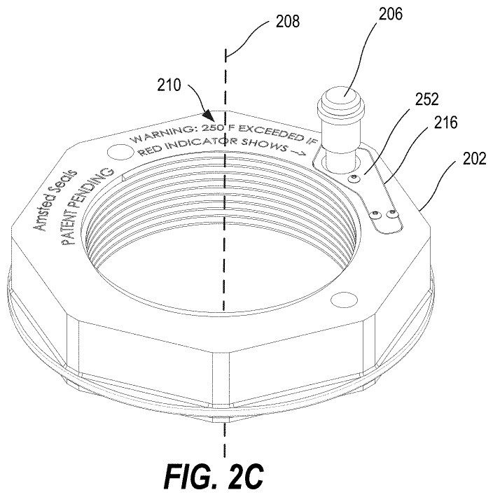

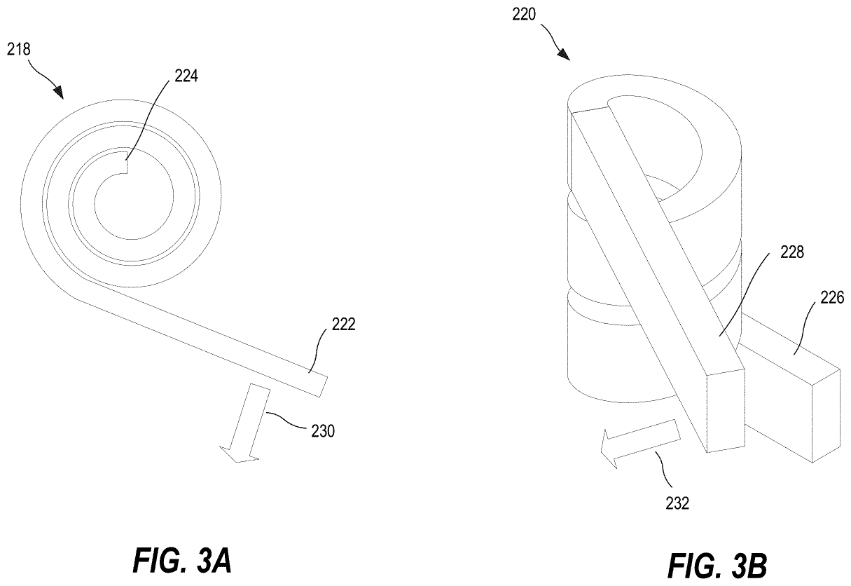

FIG. 2A is a top view of a threaded fastener 200 that uses a bimetallic spring to indicate high temperature. FIG. 2B shows the threaded fastener 200 of FIG. 2 with a cover plate 252 removed. FIG. 2C is a perspective view of the threaded fastener 200. FIG. 3A is a top view of a flat coil spring that may be used with the threaded fastener 200. FIG. 3B is a perspective view of a helical coil spring that may be used with the threaded fastener 200. FIGS. 2A-2C and 3A-3B are best viewed together in the following discussion.

As shown in FIG. 2A, the threaded fastener 200 includes a nut 202 and a positioner 204. Plungers 214(1) and 214(2) interact with the positioner 204 as described above. The nut 202 is symmetric around a rotational axis 208. The nut 202, positioner 204, plungers 214(1) and 214(2), and rotation axis 208 are examples of the nut 102, positioner 104, plungers 106(1) and 106(2), and rotation axis 124 of FIG. 1. In some embodiments, the threaded fastener 200 includes only the nut 202 (i.e., excludes the positioner 204).

A high-temperature indicator may be in the form of a pin 206. In embodiments, a bimetallic strip retains the pin 206 in a retracted position inside a pocket 216 that is formed downward from a top face 203 of the nut 202. The top face 203 is an outward-facing surface of the nut 202, i.e., a face that is visible to a person when the nut 202 is installed. The bimetallic strip includes two pieces of different metals (e.g., steel and copper) that are joined (e.g., via riveting, brazing, welding, etc.) along their length and have different coefficients of thermal expansion. In response to a change in temperature, the two pieces of metal expand and contract at different rates, causing the bimetallic strip to mechanically deflect or move.

The bimetallic strip may take any number of forms. In some embodiments, the bimetallic strip is shaped as a flat coil spring 218, as shown in FIGS. 2B and 3A. The coil spring 218 is “flat” in that the windings form a spiral within a two-dimensional plane. The flat coil spring 218 has a fixed end 224 whose position is fixed relative to the nut 202. The flat coil spring 218 also has a movable end 222, opposite the fixed end 224, which moves in the direction of the arrow 230 in response to increasing temperature. In other embodiments, the bimetallic strip is shaped as a helical coil spring 220, as shown in FIG. 3B. The helical coil spring 220 has a fixed end 226 whose position is fixed relative to the nut 202. The helical coil spring 220 also has a movable end 228, opposite to the fixed end 226, which moves in the direction of the arrow 232 in response to increasing temperature. The helical coil spring 220 may be tapered such that the radius of the windings changes with height. In other embodiments, the bimetallic strip is a flat strip (as opposed to a spring) that bends in response to changing temperature. The bimetallic strip may have a different geometry without departing from the scope hereof.

An increase in temperature causes the movable end of the bimetallic strip to deflect, releasing the pin 206 to the raised position shown in FIG. 2C. The pin 206 may be manually returned to the retracted position when the temperature of the nut 202 is no longer elevated. In some embodiments, a message area 210 on the top face 203 includes information that about how to interpret the position of the pin 206. One or more other messages 212 may also be included on the top face 203. In other embodiments, no messages are shown on the top face 203.

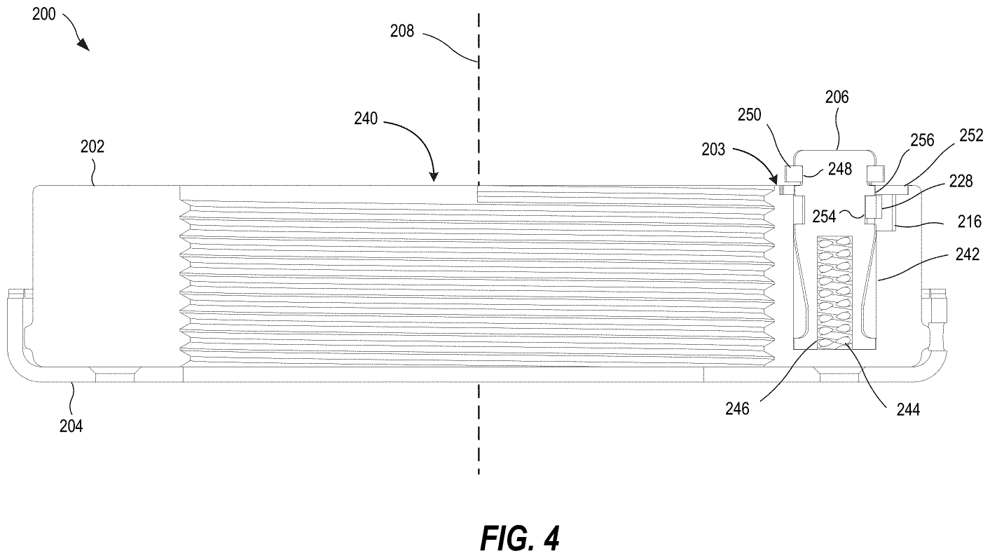

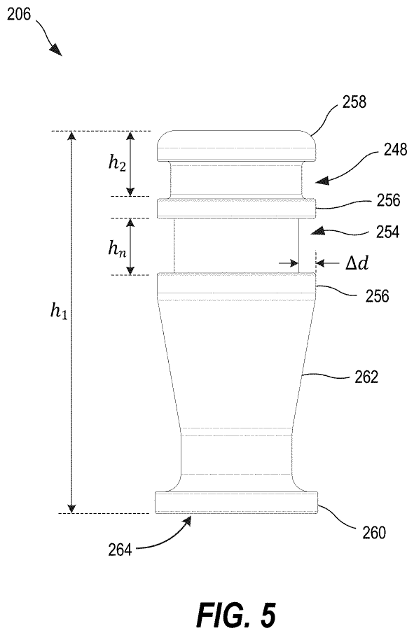

FIG. 4 is a side cutaway view of the threaded fastener 200 of FIG. 2A. FIG. 5 is a side view of the pin 206. FIGS. 4 and 5 are best viewed together in the following discussion. The threaded fastener 200 includes the nut 202 and positioner 204 (although in one embodiment, the threaded fastener 200 includes only the nut 202, as described previously). The nut 202 is symmetric around the rotation axis 208 (e.g., six-fold symmetry when the nut 202 is shaped as a hexagon). The nut 202 includes a threaded center hole 240 that is an example of the threaded center hole 122 of FIG. 1. The pin 206 is located in a shaft 242, which extends axially downward from the top face 203 and is adjacent to the pocket 216. In embodiments, the pin 206 is cylindrically symmetric and the shaft 242 is cylindrical with a circumference slightly larger than the circumference of the pin 206. The pin 206 is spring-loaded by a spring 244 that is located at least partially inside a blind hole 246 that extends axially upward from a bottom face 264 of the pin 206. Accordingly, the pin 206 is also referred to herein as a “spring-loaded indicator”.

In some embodiments, the pin 206 includes an o-ring groove 248 that laterally circumscribes the pin 206 and extends laterally inward from a sidewall 256 of the pin 206. The o-ring groove 248 is sized to accept an o-ring 250 that forms a seal with the cover plate 252. Advantageously, the o-ring 250 helps keep dirt and debris out of the pocket 216, where it can interfere with the movement of the bimetallic strip. The cover plate 252 is sized and shaped to cover the pocket 216. A notch 254 extends laterally inward from a sidewall 256 of the pin 206 and laterally circumscribes the pin 206. The notch 254 is shaped to receive the movable end 222 of the flat coil spring 218 such that when the movable end 222 is seated in the notch 254, the pin 206 is axially restrained in the shaft 242. Herein, the terms “lateral” and “laterally” refer to directions perpendicular to the rotation axis 208. By contrast, the terms “axial” and “axially” refer to the directions parallel to the rotation axis 208.

In other embodiments, the o-ring groove 248 and notch 254 are combined into a single extended notch that combines the functionalities of the o-ring groove 248 and notch 254. In this case, the o-ring 250 acts more like a gasket. Advantageously, the extended notch is easier to fabricate, as compared to the o-ring groove 248 and notch 254, because it has one fewer feature to machine.

FIG. 4 shows the movable end 222 of the flat coil spring 218 seated in the notch 254. Embodiments disclosed herein apply equally to the movable end 228 of the helical coil spring 220. The fixed end 224 and body of the flat coil spring 218 are retained within the pocket 216, as shown in FIG. 2C. Similarly, the fixed end 226 and body of the helical coil spring 220 may be retained within the pocket 216. All discussions herein may be understood to apply to the flat coil spring 218 and the helical coil spring 220. As the temperature of the threaded fastener 200 increases, the movable end 222 laterally deflects such that when a threshold temperature is reached the movable end 222 is completely removed from the notch 254, thereby causing the spring 244 to propel the pin 206 upward and out of the shaft 242, as shown in FIG. 2C.

A side view of the pin 206 is shown in FIG. 5. Although the pin 206 includes features as discussed herein, variations may be made in the shape and number of these features without departing from the scope hereof. The pin 206 has an overall axial height denoted h₁. Of the height h₁, a cap 258 of the pin 206 with height h₂ protrudes above the top face 203 of nut 202 when the pin 206 is in the retained position. The height h₂ includes the o-ring groove 248. To provide an indication that the temperature has exceeded the threshold, an enhance visibility, the cap 258 may be natural-colored or colored darker (e.g., with paint or anodization) to decrease visibility. Alternatively, the cap 258 may have a bright color, such as red, to increase visibility. As shown in FIG. 4, part of the o-ring 250 may also be visible. Accordingly, the o-ring 250 may also be colored to increase or decrease visibility.

The pin 206 is cylindrically symmetric with a sidewall represented at 256. The cap 258 and a bottom flange 260 of the pin 206 have approximately the same sidewall circumference as represented at sidewall 256. In embodiments, the bottom flange 260 may have a slightly larger circumference than the sidewall 256. An opening in the cover plate 252 may be sized so that the sidewall 256 passes through the opening while the bottom flange 260 catches on the opening and retains the pin 206 in the shaft 242 when the flat coil spring 218 releases the pin 206. In other embodiments, the pin 206 is non-cylindrical (e.g., square, rectangular, triangular, hexagonal, etc.).

In some embodiments, the pin 206 includes a tapered section 262 between the notch 254 and bottom flange 260. The tapered section 262 makes it easier to manually set the pin 206 in the retracted position by using an axial downward force (e.g., as applied to the pin 206 with a hand or finger) to laterally deflect the movable end 222. The tapered section 262 has a diameter that decreases with increasing axial distance from the sidewall 256 just below the notch 254. As the pin 206 is pushed downward, the tapered section 262 laterally deflects the movable end 222 (or alternatively the movable end 228) until the movable end 222 snaps into the notch 254 (i.e., the movable end 222 is seated in the notch 254. This method of setting the pin 206 requires the temperature to be below threshold.

In other embodiments, the pin 206 excludes the tapered section 262. In these embodiments, the sidewall 256 may have a constant diameter between the notch 254 and bottom flange 260. Alternatively, the sidewall 256 may have a different shape or profile between the notch 254 and bottom flange 260.

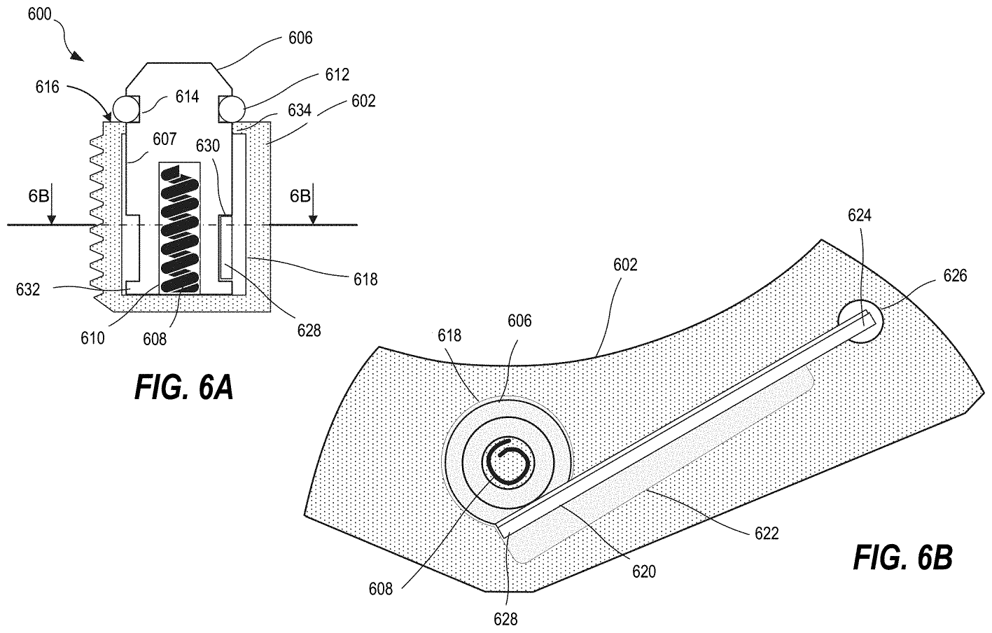

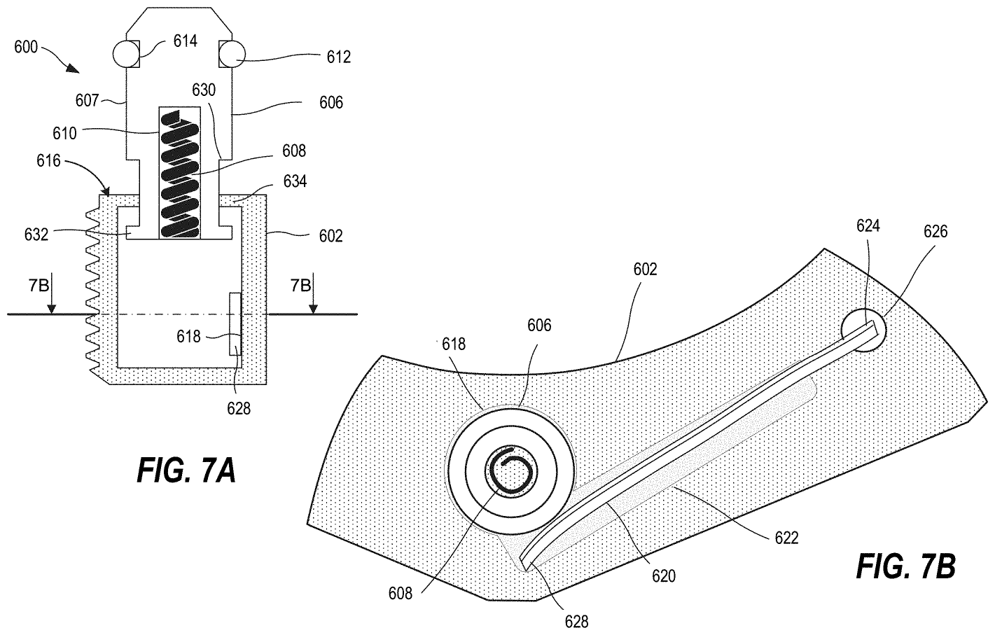

FIG. 6A is a side cross-sectional view of a threaded fastener 600 that uses a leaf spring to indicate high temperature. FIG. 6B is a cross-sectional view of the threaded fastener 600 of FIG. 6A along the line 6B-6B. FIG. 7A is a cross-sectional view of the threaded fastener 600 when a threshold temperature has been reached or exceeded. FIG. 7B is a cross-sectional view of the threaded fastener 600 along the line 7B-7B. FIGS. 6A, 6B, 7A, and 7B are best viewed together in the following discussion.

The threaded fastener 600 includes a nut 602 that is an example of the nuts 102 and 202. For clarity, only a portion of the nut 602 is shown in FIGS. 6A, 6B, 7A, and 7B. The threaded fastener 600 also includes a pin 606 that is an example of the pin 206. Although a positioner is not shown, the discussion herein is not limited to the specific nut 602 and may also encompass a threaded fastener with a positioner (e.g., the positioner 104 of FIG. 1). The nut 602 forms a pocket 622 and a shaft 618 that extend downward from a top face 616 of the nut 602. The top face 616 is an outward-facing surface of the nut 602 that is visible when the nut 602 is installed. The shaft 618 is located adjacent to the pocket 622 and partially opens to the pocket 622. In embodiments, the pin 606 is cylindrically symmetric and the shaft 618 is cylindrical with a circumference slightly larger than that of the pin 606, thereby allowing the pin 606 to move axially within the shaft 618. The pin 606 is spring-loaded by a spring 608 that is at least partially located inside a blind hole 610 that extends axially upward from a bottom face of the pin 606. Accordingly, the pin 606 may also referred to herein as a “spring-loaded indicator”.

In some embodiments, the pin 606 forms an o-ring groove 614 that laterally circumscribes the pin 606, extending laterally inward from a sidewall 607 of the pin 606. The o-ring groove 614 is sized to accept an o-ring 612 that laterally circumscribes the pin 606 and forms a seal with the top face 616 of the nut 602 to keep contaminants out of the shaft 618 and pocket 622. In embodiments, a cover plate (not shown) may be sized and shaped to cover the pocket 622. In embodiments, the pin 606 does not form the o-ring groove 614, in which case the o-ring 612 is not used.

The pin 606 also forms a notch 630 that laterally circumscribes the pin 606, extending laterally inward from the sidewall 607 of the pin 606. The notch 630, which is similar to the notch 254 shown in FIG. 5, is shaped to receive a movable end 628 of a leaf spring 620. When the movable end 628 is seated in the notch 630, the pin 606 is axially restrained in the shaft 618, as shown in FIG. 6A. Although the notch 630 is shown at a particular axial position along the pin 606, the notch 630 may be located at different axial position.

In embodiments, the leaf spring 620 is a bimetallic strip that is similar to the flat coil spring 218 and helical coil spring 220 described above, except without loops. A fixed end 624 of the leaf spring 620 is positioned in the pocket 622 while the movable end 628 is located in the shaft 618. In embodiments, the fixed end 624 is anchored, or held in place, by a set screw 626. However, another mechanism for anchoring the fixed end 624 may be used. As the temperature of the threaded fastener 600 increases and crosses a threshold temperature, the movable end 628 deflects laterally away from the pin 606 and out of the notch 630, thereby releasing the pin 606, as shown in FIG. 7A.

In some embodiments, the pin 606 includes a bottom flange 632 which defines a lower edge of the notch 630. The bottom flange 632 engages with a lip 634 in the top face 616 to prevent the pin 606 from completely leaving the shaft 618 when released by the leaf spring 620. The bottom flange 632 may have a slightly larger circumference than sidewall 607. An opening in the shaft 618 at the top face 616 may be sized so that the sidewall 607 passes through the opening while the bottom flange 632 catches on the lip 634. When the shaft 618 is a blind hole, the lip 634 may be part of the cover plate (as opposed to being an integral part of the nut 602).

When the threaded fastener 600 reaches the threshold temperature, the leaf spring 620 releases the pin 606. Later, when the threaded fastener 600 is inspected, the temperature may have dropped below the threshold so that potential damage is not apparent without careful visual inspection of the fastener or bearing. The presence of the pin 606 at an extended position above the top face 616 of the nut 602 indicates to a user that a closer inspection for damage should be made. After this inspection, the leaf spring 620 may have returned to its original, undeflected position. In this case, the movable end 628 may be manually deflected such that the bottom flange 632 of the pin 606 can be pushed downward, past the movable end 628, to reseat the movable end 628 in the notch 630. To facilitate this reseating, the pin 606 may include a tapered section that is similar to the tapered section 262 of the pin 206 shown in FIG. 5.

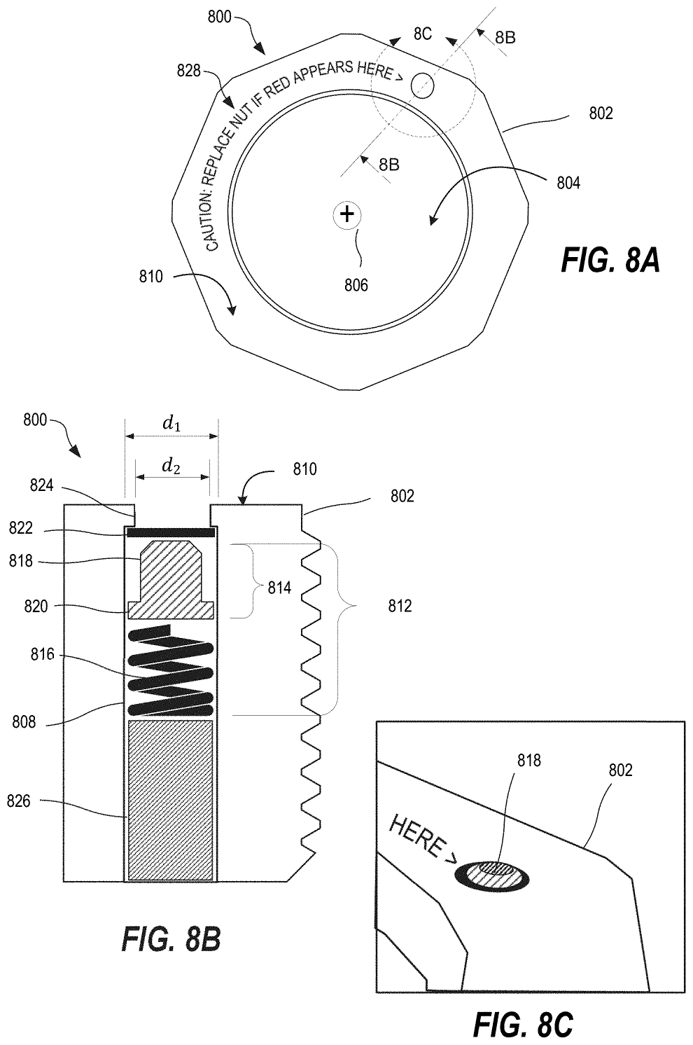

FIG. 8A is a top view of a threaded fastener 800 with a high-temperature indicator, in an embodiment. FIGS. 8B and 8C are cross-sectional and perspective views, respectively, of the threaded fastener of FIG. 8A. FIGS. 8A-8C are best viewed together in the following discussion.

The threaded fastener 800 includes a nut 802 with a threaded center hole 804 around a rotation axis 806. The nut 802 is an example of the nuts 102, 202, and 602. A shaft 808 extends axially downward from a top face 810 of the nut 802,c the top face 810 at least partially encircling the threaded center hole 804. The top face 810 is an outward-facing surface of the nut 802 that is visible when the nut 802 is installed. A spring-loaded indicator 812 is located in the shaft 808. A temperature-sensitive material 822 is located in the shaft 808 to axially restrain the spring-loaded indicator 812 such that the temperature-sensitive material 822, in response to reaching a threshold temperature, softens or changes to a liquid, thereby releasing the spring-loaded indicator 812.

The nut 802 forms a lip 824 where the shaft 808 meets the top face 810. In embodiments, the shaft 808 is shaped as a cylinder with a shaft diameter d₁. Furthermore, the lip 824 is shaped as a cylinder with a lip diameter d₂ that is less than d₁. The shaft diameter d₁ may be slightly larger than that of the spring-loaded indicator 812 such that shaft 808 does not constrain axial motion of the spring-loaded indicator 812.

In embodiments, the spring-loaded indicator 812 includes a cylindrically symmetric pin 814 and a spring 816. The pin 814 includes a body 818 whose diameter is less than the lip diameter d₂ and a base 820 whose diameter is greater than the lip diameter d₂. The spring 816 axially pushes the base 820 against the lip 824 when the spring-loaded indicator is released. Thus, the lip 824 prevents the spring-loaded indicator 812 from completely falling out of the shaft 808. In embodiments, the shaft 808 extends through the entire axial height of the nut 802 and the spring 816 is compressed between the pin 814 and a plug 826 in the shaft 808. Alternatively, the shaft 808 may extend through only a portion of the axial height of the nut 802. In this case, the spring 816 may be compressed between the pin 814 and a base of the shaft 808.

In embodiments, the temperature-sensitive material 822 is shaped as a disc that the spring-loaded indicator 812 axially pushes against the lip 824. In embodiments, the temperature-sensitive material 822 is one of an alloy (e.g., containing indium, tin, and lead) and a high-temperature polymer (e.g., plastic) that is a solid at ambient temperatures. When the threaded fastener 800 reaches a threshold temperature at which the temperature-sensitive material 822 melts, the pin 814 is released, and the spring 816 pushes the body 818 of the pin 814 upward to at least partially protrude above the top face 810, as shown in FIG. 8C. Different alloys and polymers have different threshold temperatures, which may be selected for the application at hand.

In some embodiments, a message area 828 on the top face 810 of the nut 802 includes information about how to interpret the position of the pin 206. The message area 828 is similar the message area 210 shown in FIG. 2A. Alternatively, the nut 802 may exclude the message area 828.

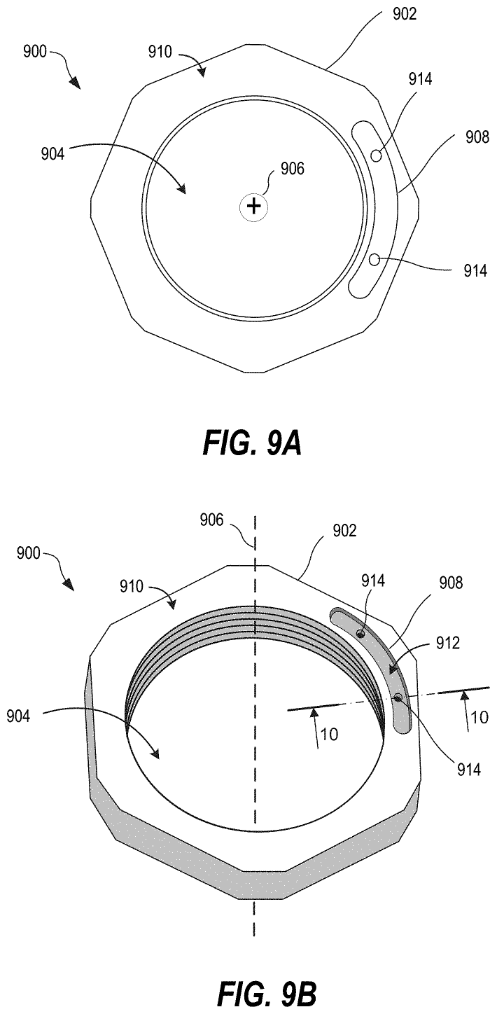

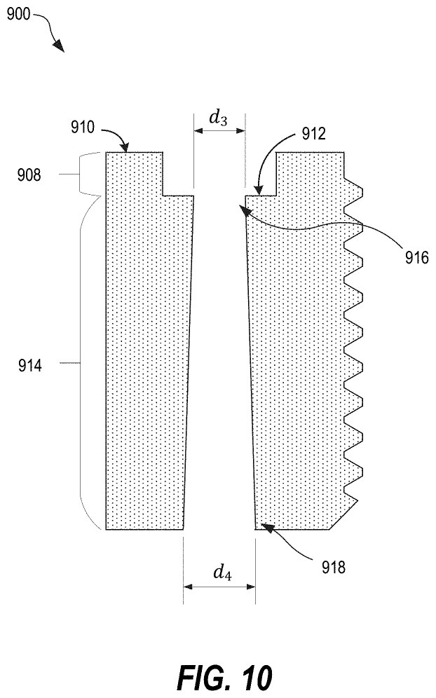

FIG. 9A is a top view of a threaded fastener 900 with a high-temperature indicator. FIG. 9B is perspective view of the threaded fastener 900 of FIG. 9A. FIG. 10 is a cross-sectional view of the threaded fastener 900 along the line 10B-10B. FIGS. 9A, 9B, and 10 are best viewed together in the following discussion.

The threaded fastener 900 includes a nut 902 that forms a threaded center hole 904 around a rotation axis 906. The nut 802 is an example of the nuts 102, 202, 602, and 802. The nut 902 forms a pocket 908 that extends axially downward from a top face 910 of the nut 902. The top face 910 at least partially encircles the threaded center hole 904. The top face 910 is an outward-facing surface of the nut 802 that is visible when the nut 802 is installed (e.g., as part of a wheel-end system). An indicator, or warning message, is located in the pocket 908. In embodiments, the indicator is located on or near a bottom face 912 of the pocket 908 and may be a color that is different from that of nut 902, such as red. A temperature-sensitive material is located in the pocket 908 and axially covers the indicator. In embodiments, the temperature-sensitive material is one of an alloy (e.g., containing indium, tin, and lead) and a high-temperature polymer (e.g., plastic) that is a solid at ambient temperatures. In response to reaching a threshold temperature, the temperature sensitive material changes to a liquid that flows out of the pocket 908 to visibly reveal the indicator.

In embodiments, the nut 902 forms one or more sprues 914 that extend axially downward from the bottom face 912 of the pocket 908. Each of the sprues 914 may be shaped as a frustrum with a top base 916 and a bottom base 918, the top base 916 being located axially closer to the bottom face 912 of the pocket 908 than the bottom base 918. The top base 916 has a top diameter d₃ that is smaller than a bottom diameter d₄ of the bottom base 918. As shown in FIG. 10, each of the sprues 914 may be shaped as a right circular conical frustrum, however other shapes for the sprues 914 are contemplated.

In embodiments, a temperature-sensitive material is melted and solidified (brazed) into the pocket 908. The temperature-sensitive material also fills at least part of each of the one or more sprues 914. In embodiments, the sprues 914 are optionally included to provide increased adhesion of the temperature-sensitive material to nut 902. It may have a slight taper along the axial length of sprues 914 helps hold the temperature-sensitive material in place. Specifically, the tapered shape of the sprues 914 prevents solidified temperature-sensitive material from sliding out of the sprues 914.

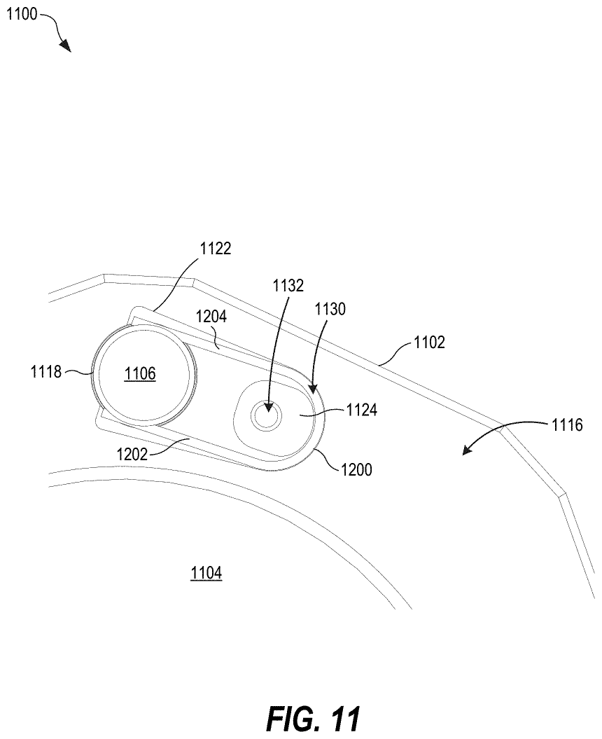

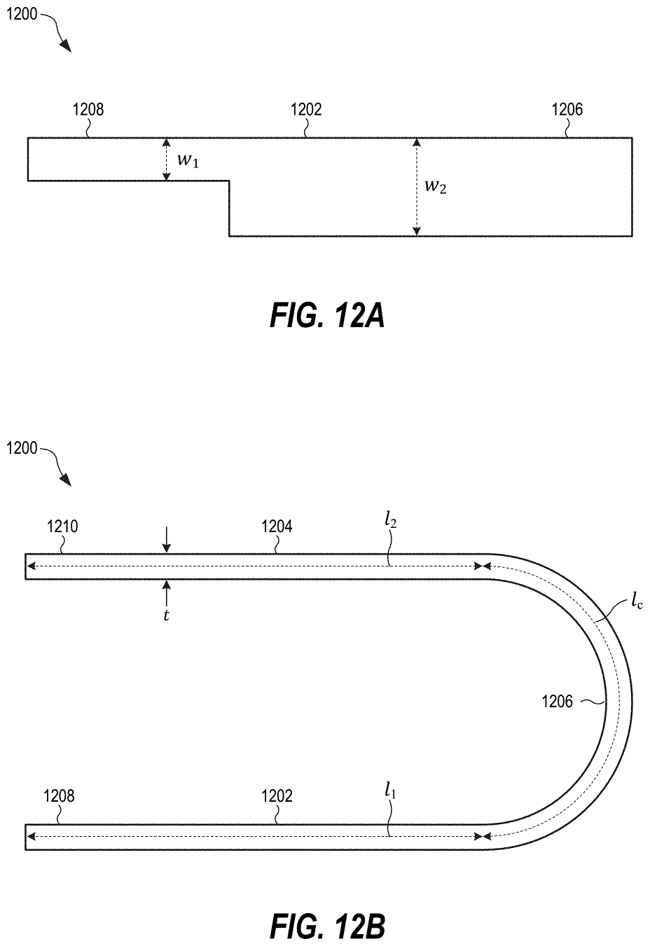

FIG. 11 is a top view of a threaded fastener 1100 with a high-temperature indicator. FIGS. 12A and 12B are side and top views, respectively, of a u-shaped bimetallic strip 1200 used with the threaded fastener 1100 of FIG. 11. FIGS. 11, 12AB, and 12B are best viewed together in the following discussion.

The threaded fastener 1100 includes a nut 1102 that forms a threaded center hole 1104 around a rotation axis (not shown). The nut 1102 is an example of the nuts 102, 202, 602, 802, and 902. For clarity, only a portion of the nut 1102 is shown in FIG. 11. Although a positioner is not shown in FIG. 11, the discussion herein is not limited to the specific nut 1102. Accordingly, in one embodiment, the threaded fastener 1100 includes both the nut 1102 and a positioner (e.g., the positioner 104 of FIG. 1).

The nut 1102 forms a pocket 1122 and a shaft 1118 that extend downward from a top face 1116 of the nut 1102. The top face 1116 is an outward-facing surface of the nut 1102 that is visible when the nut 1102 is installed (e.g., as part of a wheel-end system). The threaded fastener 1100 also includes a pin 1106 that fits at least partially in the shaft 1118. The pin 1106 is an example of the pins 206 and 606. The shaft 1118 is located adjacent to the pocket 1122 and partially opens to the pocket 1122. In embodiments, the pin 1106 is cylindrically symmetric and the shaft 1118 is cylindrical with a circumference slightly larger than that of the pin 1106, thereby allowing the pin 1106 to move axially within the shaft 1118. The pin 1106 is spring-loaded, similar to the pins 206 and 606 (see FIGS. 6A, 6B, 7A, and 7B). Accordingly, the pin 1106 is also referred to herein as a “spring-loaded indicator”.

As shown in FIGS. 12A and 12B, the u-shaped bimetallic strip 1200 includes a first leg 1202 and a second leg 1204 that are joined to a curved section 1206. As shown in FIG. 11, both the first leg 1202 and second leg 1204 extend laterally from the pocket 1122 into the shaft 1118. The first leg 1202 has a first movable end 1208 that engages with a notch in the pin 1106, i.e., the first movable end 1208 is seated in the notch when the pin 1106 is in the retracted position. The second leg 1204 has a second movable end 1210 that also engages with the notch. The notch (not shown in FIG. 11) is similar to the notch 254 of the pin 206 (see FIGS. 4 and 5) and each of the movable ends 1208 and 1210 is similar to the movable end 228 of FIGS. 3 and 4. The movable ends 1208 and 1210, when seated in the notch, axially restrain the pin 1106 from opposite lateral sides. When the temperature exceeds the threshold temperature, the movable ends 1208 and 1210 deflect in opposite lateral directions to release the pin 1106.

The nut 1102 also includes a boss 1124 that forms a channel 1130 with a side wall of the pocket 1122. The channel 1130 has a geometry to accept the curved section 1206, or a portion thereof. As shown in FIG. 11, the side wall of the pocket 1122 may be curved to match the curvature of the curved section 1206. The boss 1124 is located fully in the pocket 1122 (i.e., not in the shaft 1118) and therefore does not directly contact the movable ends 1208 and 1210. The boss 1124 may also not directly contact the legs 1202 and 1204.

The boss 1124 and channel 1130 simplify the assembly of the threaded fastener 1100 by providing a convenient location within which the u-shaped bimetallic strip 1200 can be placed before the pin 1106 is inserted into the shaft 1118 and a cover plate is attached over the pocket 1122. The boss 1124 may be integrally formed as part of the nut 1102. For example, the pocket 1122 may be machined to form the boss 1124. Alternatively, the boss 1124 may be a separate part that is bolted into the pocket 1122. For example, the boss 1124 may form a through-hole through which a bolt passes to engage with a threaded hole formed in the bottom face of the pocket 1122. The boss 1124 may alternatively form a slot that allows the boss 1124 to be translated in the direction parallel to the legs 1202 and 1204. This translation changes the thickness of the channel 1130. After the u-shaped bimetallic strip 1200 has been inserted into the pocket 1122 and the channel 1130, the boss 1124 may be translated to push the curved section 1206 against the side wall, thereby reducing the thickness of the channel 1130 such that the boss 1124 anchors (i.e., physically constrains) the curved section 1206 against the side wall. Anchoring the curved section 1206 may advantageously increase the thermal conductivity between the curved section 1206 and the nut 1102. The curved section 1206 may be anchored to the nut 1102 in another way without departing from the scope hereof (e.g., with a set screw). However, it is not necessary to anchor any portion of the u-shaped bimetallic strip 1200. In fact, by not anchoring the bimetallic strip 1200, assembly of the threaded fastener 1100 is simplified.

The thermal deflection B(T) of the movable ends 1208 and 1210 as a function of temperature T is given mathematically by:

$$B ( T ) = 0.265 F \frac{( T - {T}_{0} ) {L}^{2}}{t} \qquad ( 1 )$$

where F is the flexivity, t is the thickness of the bimetallic strip 1200, T₀ is an initial temperature (e.g., the temperature of the bimetallic strip 1200 when it is installed), and L=l₁+l₂+l_{c} is the total length of the bimetallic strip 1200, where l₁ is the length of the first leg 1202, l₂ is the length of the second leg 1204, and l_{c} is the length of the curved section 1206. For the movable ends 1208 and 1210 to release the pin 1106 at a threshold temperature Tₜₕ, the deflection Bₜₕ=B(Tₜₕ) should approximately equal the lateral width Δd of the notch (e.g., see the lateral width Δd of the notch 254 in FIG. 5), i.e., Δd≈Bₜₕ=0.265F(Tₜₕ−T₀)L²/t.

The mechanical force P needed to deflect the movable ends 1208 and 1210 by a distance Δx is given mathematically by:

$$P = 16 E \frac{w {t}^{3}}{{L}^{3}} Δ x = k Δ x \qquad ( 2 )$$

where E is the modulus of elasticity. Eqn. 2 may be interpreted as Hooke's law. In this case, the bimetallic strip 1200 acts like a spring with a spring constant k=16Ewt³/L³.

If the spring constant k is too small, mechanical forces (e.g., vibrations) arising during operation of the vehicle may cause Δx to be larger than Δd for temperature less than Tₜₕ. In this case, the movable ends 1208 and 1210 will deflect out of the notch, causing the pin 1106 to release even though the temperature never exceeded the threshold. In this case, the high-temperature indicator incorrectly indicates excessive temperature. To prevent this situation from arising, the spring constant k may be increased such that Δx<Δd for the largest mechanical forces that may be exerted on the bimetallic strip 1200 during normal operation of the wheel-end system. From Eqn. 2, the spring constant k can be increased by (1) increasing the thickness t, (2) increasing the width w, and (3) decreasing the total length L. However, the first two of these options decrease the thermal deflection Bₜₕ. To account for the thermal deflection, Bₜₕ may be substituted for Δx in Eqn. 2 to obtain the thermal force Pₜₕ:

$${P}_{t h} = 16 E \frac{w {t}^{3}}{{L}^{3}} B ( {T}_{t h} ) = 4.24 E F ( {T}_{t h} - {T}_{0} ) \frac{w {t}^{2}}{L} \qquad ( 3 )$$

Here, the thermal force Pₜₕ arises from differential thermal expansion and contraction of the bimetallic strip 1200, as opposed to external mechanical forces. Note that the condition Δx<Δd described above is equivalent to P<Pₜₕ, i.e., all external mechanical forces exerted on the bimetallic strip should ideally be less than the thermal force Pₜₕ. Also note that the width w does not appear in Eqn. 1 and therefore may be adjusted to change the thermal force Pₜₕ without changing the thermal deflection Bₜₕ.

FIG. 12A shows how to increase the width of the bimetallic strip 1200 without increasing the height hₙ of the notch on the pin 1106. The bimetallic strip 1200 has a width w₂ at the curved section 1206 and most of the legs 1202 and 1204. However, the width decreases w₁<w₂ near the movable ends 1208 and 1210. The width w₁ is less than the height hₙ (see FIG. 5) so that the movable ends 1208 and 1210 can fit into the notch and axially restrain the pin 1106. The smaller width w₁ has a negligible effect on the mechanical and thermal dynamics of the bimetallic strip 1200. Therefore, the larger value of w₂ is used in Eqn. 3.

While FIG. 12A shows the a step-wise transition between w₁ and w₂ occurring near the middle of each of the legs 1202 and 1204, the transition may alternatively occur closer to the movable ends 1208 and 1210. Alternatively, the transition may occur closer to the curved section 1206. Furthermore, the transition need not be shaped as a step. For example, the legs 1202 and 1204 may gradually change between w₂ and w₁. In some embodiments, the bimetallic strip 1200 has a singular width (i.e., does not transition between widths).

In some embodiments, the boss 1124 forms a threaded fastener hole 1132 that extends axially downward from a top face of the boss 1124. The fastener hole 1132 is sized to accept a fastener that affixes a cover plate over the pocket 1122. This cover plate, which is not shown in FIG. 11 for clarity, is similar to the cover plate 252 shown in FIGS. 2A and 4. In some embodiments, the threaded fastener 1100 further includes this cover plate.

In other embodiments, the nut 1102 excludes the boss 1124. Instead, the nut 1102 forms a threaded fastener hole extending axially downward from the bottom face of the pocket 1122. The threaded fastener hole may be positioned so that when a fastener (e.g., a screw) is inserted into the threaded fastener hole, the curved section 1206 partially encircles a shank of the fastener. In some embodiments, the fastener also passes through a through-hole in the cover plate to engage with the threaded fastener hole, thereby affixing the cover plate to the nut 1102. The cover plate forms the through-hole such that when the cover plate is positioned over the pocket 1122, the through-hole is laterally aligned with the threaded fastener hole.

Any of the threaded fasteners disclosed herein may incorporate messages on its top surface. Examples of such messages are shown in FIGS. 2A-2C (see message area 210) and 8A (see message area 828). As another example, the top face 203 of the nut 202 may include a message 212 that visually indicates to a user when the plunger 214(1) is properly seated in the positioner ring. The message 212 may include, for example, an arrow next to the plunger 214(1) that points to the outer circumference of the nut 202. When the plunger 214(1) is properly seated, the arrow will be aligned with one of a plurality of indicator notches 238 formed along the circumference of the positioner ring. The plunger 214(2) may similarly have an arrow marked on the top face 203 to indicate when it is properly seated in one of the recesses 114 of the positioner 204. The plungers 214(1) and 214(2) may be positioned such that they do not simultaneously engage with two recesses 114 of the positioner 204. Thus, a user installing the threaded fastener 200 will know that the nut 202 is properly fastened when only one of the plungers 214(1) and 214(2) has an arrow aligned with one of the indicator notches 238. Other messages on the top face 203 of the nut 202 may include a manufacturer's name or a part number, for example.

Any of the threaded fasteners (e.g., threaded fasteners 100, 200, 600, 800, and 1100) and nuts (e.g., nuts 102, 202, 602, 802, and 1102) presented herein may be used as an axle nut for securing a wheel to a threaded spindle or drive axle. In this case, the axle nut forms part of a wheel-end system and the top face (e.g., top faces 203, 616, 810, and 1116) is an outward-facing surface that faces away from the corresponding bearing and bearing seals of the wheel-end system. When installed, the top face will only be visible when no other wheel-end component (e.g., a hub cap or center cap) is present to visibly occlude the high-temperature indicator.

Accordingly, the present embodiments include other wheel-end components that have a high-temperature indicator located on an outward-facing surface. In some embodiments, a hub cap includes an outward-facing surface that, when installed as part of a wheel-end system, faces away from the corresponding bearing and bearing seal of the wheel-end system. The high-temperature indicator is located on the outward-facing surface of the hub cap, where it is unlikely to be visibly occluded since, in general, no other common component of a wheel-end system is intended to cover a hub cap. These hub caps are similar to the nuts presented above except that they usually do not form a threaded center through-hole (although they may form a threaded center blind hole). Accordingly, the high-temperature indicator may be located laterally closer to the rotation axis. Furthermore, the outward-facing surface of a hub cap may not be planar. A center cap may be used instead of the hub cap without departing from the scope hereof.

In other embodiments, a wheel hub includes an outward-facing surface that, when installed as part of a wheel-end system, faces away from the corresponding bearing and bearing seal of the wheel-end system. The high-temperature indicator is located on the outward-facing surface of the wheel hub. To prevent the indicator from being occluded by other wheel-end components (e.g., an axle nut), it may be located laterally farther from the rotation axis. For example, the indicator may be located at a radial position, relative to the rotation axis, that is greater than the radius of the axle nut and hub cap.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A device for a wheel-end system, comprising:
a component of the wheel-end system that defines a rotation axis and forms (i) a pocket extending axially downward from a top face of the component and (ii) a shaft extending axially downward from the top face and laterally adjacent to the pocket, the shaft being partially open to the pocket;
a spring-loaded indicator located at least partially in the shaft; and
a bimetallic strip located partially in the pocket and extending laterally into the shaft, the bimetallic strip having a movable end that axially restrains the spring-loaded indicator while a temperature of the component is below a threshold temperature;
wherein the bimetallic strip, in response to the temperature exceeding the threshold temperature, laterally deflects the movable end to release the spring-loaded indicator.

2. The device of claim 1, wherein the component is one of an axle nut, a hub cap, a spacer, a wheel hub, and a center cap.

3. The device of claim 1, the bimetallic strip including:
a fixed end, opposite the movable end, that is anchored in the pocket; and
a middle section, located between the fixed and movable ends, that is shaped as a coil.

4. The device of claim 1, the spring-loaded indicator including a pin that at least partially protrudes above the top face when the spring-loaded indicator is released.

5. The device of claim 4, the pin forming one or more notches that extend laterally inward from a side wall of the pin, each of the one or more notches being shaped such that the movable end, when located therein, axially restrains the pin.

6. The device of claim 5, wherein the one or more notches comprise a single notch that laterally circumscribes the pin.

7. The device of claim 5, further comprising an o-ring that laterally circumscribes the spring-loaded indicator and seals the shaft near the top face.

8. The device of claim 7, the pin forming an o-ring groove that laterally circumscribes the pin, the o-ring groove being sized to accept the o-ring.

9. The device of claim 5, the pin including:
a tapered section, located below the one or more notches, having a diameter that decreases with increasing axial distance from the one or more notches; and
a bottom flange located below the tapered section.

10. The device of claim 5, the spring-loaded indicator further including a spring located at least partially inside a blind hole that extends axially upward from a bottom face of the pin.

11. The device of claim 4, wherein the shaft is cylindrical and the pin is cylindrically symmetric.

12. The device of claim 1, further comprising a cover plate that covers the pocket.

13. The device of claim 1, wherein:
the movable end is a first movable end of the bimetallic strip;
the bimetallic strip further includes a second movable end opposite to the first movable end;
the first and second movable ends axially restrain the spring-loaded indicator from opposing lateral sides while the temperature of the component is below the threshold temperature; and
the bimetallic strip, in response to the temperature exceeding the threshold temperature, laterally deflects the first and second movable ends in opposite lateral directions to release the spring-loaded indicator.

14. The device of claim 13, wherein:
the bimetallic strip includes a curved section that is located between the first and second movable ends; and
the component includes a boss that is located in the pocket and forms a curved channel with a side wall of the pocket, the curved channel having a geometry to accept the curved section.

15. The device of claim 14, the boss being integrally formed with the component.

16. The device of claim 14, the boss forming a threaded fastener hole that extends axially downward from a top face of the boss.

17. The device of claim 16, the threaded fastener hole being sized to receive a screw that affixes a cover plate over the pocket.

18. The device of claim 13, wherein:
the bimetallic strip includes a curved section that is located between the first and second movable ends; and
the component forms a threaded fastener hole that extends axially downward from a bottom face of the pocket, the threaded fastener hole being located such that when a screw is inserted into the threaded fastener hole, the curved section partially encircles a shank of the screw.

19. The device of claim 18, further comprising a cover plate that covers the pocket, the cover plate forming a fastener through-hole such that when the cover plate is positioned over the pocket, the fastener through-hole is laterally aligned with the threaded fastener hole.

20. A device for a wheel-end system, comprising:
a component of the wheel-end system that defines a rotation axis and forms a pocket extending axially downward from a top face of the component;
an indicator located in the pocket; and
temperature-sensitive material located in the pocket and axially covering the indicator;
wherein the temperature-sensitive material, in response to reaching a threshold temperature, changes to a liquid that flows out of the pocket to visibly reveal the indicator.

21. The device of claim 20, wherein the component is one of an axle nut, a hub cap, a spacer, a wheel hub, and a center cap.

22. The device of claim 20, the indicator being located near a bottom face of the pocket.

23. The device of claim 20, the component further forming one or more sprues that extend axially downward from a bottom face of the pocket.

24. The device of claim 23, each of the one or more sprues being shaped as a frustrum with top and bottom bases, the top base being located axially closer to the bottom face of the pocket than the bottom base, the top base having a smaller area than the bottom base.

25. The device of claim 24, wherein each of the one or more sprues is shaped as a right circular conical frustrum.

26. The device of claim 23, wherein the temperature-sensitive material fills at least part of each of the one or more sprues.

27. The device of claim 21, wherein the temperature-sensitive material is one of an alloy and a high-temperature polymer.

28. A device for a wheel-end system, comprising:
a component of the wheel-end system that defines a rotation axis and forms a shaft extending axially downward from a top face of the component;
a spring-loaded indicator located in the shaft; and
temperature-sensitive material located in the shaft to axially restrain the spring-loaded indicator;
wherein the temperature-sensitive material, in response to reaching a threshold temperature, softens or changes to a liquid to release the spring-loaded indicator.

29. The device of claim 28, wherein the component is one of an axle nut, a hub cap, a spacer, a wheel hub, and a center cap.

30. The device of claim 28, wherein:
the component forms a lip where the shaft meets the top face;
the shaft is shaped as a cylinder with a shaft diameter; and
the lip is shaped as a cylinder with a lip diameter that that is less than the shaft diameter.

31. The device of claim 30, the spring-loaded indicator including:
a pin with (i) a body whose diameter is less than the lip diameter and (ii) a base whose diameter is greater than the lip diameter; and
a spring that axially pushes the base against the lip when the spring-loaded indicator is released.

32. The device of claim 30, wherein the temperature-sensitive material is shaped as a disc that the spring-loaded indicator axially pushes against the lip.

33. The device of claim 28, the spring-loaded indicator including a pin that at least partially protrudes above the top face when the spring-loaded indicator is released.

34. The device of claim 28, wherein the temperature-sensitive material is one of an alloy and a high-temperature polymer.
